(19) United States
(12) Patent Application Publication
(10) Pub. No.: US 2014/0099575 A1
(43) Pub. Date: Apr. 10, 2014

(54) BIO-BASED TONER COMPOSITIONS

(71) Applicants: Mark E. Mang, Rochester, NY (US); Timothy L. Lincoln, Rochester, NY (US); Brian J. Andaya, Ontario, NY (US); Deborah M. Hudson, Rochester, NY (US)

(72) Inventors: Mark E. Mang, Rochester, NY (US); Timothy L. Lincoln, Rochester, NY (US); Brian J. Andaya, Ontario, NY (US); Deborah M. Hudson, Rochester, NY (US)

(73) Assignee: Xerox Corporation

(21) Appl. No.: 13/646,412

(22) Filed: Oct. 5, 2012

(51) Int. Cl. G03G 9/16

(52) U.S. Cl. 430/105; 430/137.2

(57) ABSTRACT

Use of a resin blend of a petroleum based resin and a bio-derived polyester resins having low glass transition (Tg) values in a toner composition is disclosed. The resulting novel bio-based toner exhibits desirable characteristics such as good blocking performance and excellent fusing latitude.

### TECHNICAL FIELD

The presently disclosed embodiments are generally directed to bio-based toner compositions that exhibit desirable characteristics such as good blocking performance and excellent fusing latitude. More specifically, the presently disclosed embodiments are directed to toner compositions that include bio-derived polyester resins having low onset glass transition (Tg) values with broad Tg range (onset to endset), and melt-mix processes of making the same.

### BACKGROUND

Electrophotography, which is a method for visualizing image information by forming an electrostatic latent image, is currently employed in various fields. The term “electrostatographic” is generally used interchangeably with the term “electrophotographic.” In general, electrophotography comprises the formation of an electrostatic latent image on a photoreceptor, followed by development of the image with a developer containing a toner, and subsequent transfer of the image onto a transfer material such as paper or a sheet, and fixing the image on the transfer material by utilizing heat, a solvent, pressure and/or the like to obtain a permanent image.

In electrostatographic reproducing apparatuses, including digital, image on image, and contact electrostatic printing apparatuses, a light image of an original to be copied is typically recorded in the form of an electrostatic latent image upon a photosensitive member and the latent image is subsequently rendered visible by the application of electroscopic thermoplastic resin particles and pigment particles, or toner. Electrophotographic imaging members may include photosensitive members (photoreceptors) which are commonly utilized in electrophotographic (xerographic) processes, in either a flexible belt or a rigid drum configuration. Other members may include flexible intermediate transfer belts that are seamless or seamed, and usually formed by cutting a rectangular sheet from a web, overlapping opposite ends, and welding the overlapped ends together to form a welded seam. These electrophotographic imaging members comprise a photoconductive layer comprising a single layer or composite layers.

There is a constant desire to improve the characteristics and performance of toner compositions. One area of possible improvement focuses on the resins used in making the toner compositions. For example, resins having low Tg are often used to improve fusing performance of the toner. However, the use of such materials often leads to poor storage performance. For example, toner that is stored in a hot environment leads to blocking. Blocking is the partial fusing of toner particles together. As a consequence, the use of amorphous polyester resin with a glass transition temperature of less than 50° C. is generally avoided. In addition, growing concerns about the environment has created a need to find sustainable monomers derived from biomaterials. Thus, alternative bio-derived replacements are desired.

As such, the present embodiments are directed to toner compositions comprising polyester resins that overcome the above-mentioned issues.

### BRIEF SUMMARY

According to embodiments illustrated herein, there is provided a bio-derived toner composition comprising a polyester resin that addresses the shortcomings discussed above.

An embodiment may include a toner comprising: a resin blend comprising a petroleum based resin, and a bio-derived amorphous polyester resin having a broad Tg span with an onset to endset of about 19° C. and the onset Tg occurs between 32° C. and 36° C.; a colorant; and one or more optional additives, wherein the toner has a fusing temperature that begins at 145° C.

In another embodiment, there is provided a toner comprising: a resin blend comprising a petroleum based resin, and a bio-derived amorphous polyester resin; a colorant; and one or more optional additives, wherein the resin blend is made by melt-mixing the a petroleum based resin and the bio-derived amorphous polyester resin and further wherein the toner has a fusing temperature that begins at 145 C and an onset Tg between 40° C. and 50° C. and an endset Tg about 15° C. higher than the onset Tg value.

In another embodiment, there is provided a method of making a toner comprising melt-mixing a petroleum based resin and a bio-derived amorphous polyester resin to obtain a resin blend, wherein the bio-derived amorphous polyester resin has a broad Tg span with an onset to endset of about 19° C. and the onset Tg occurs between 32° C. and 36° C.; admixing the resin blend with a colorant and one or more optional additives to form a toner mixture; grinding the toner mixture; and classifying the ground toner mixture to form a toner.

### BRIEF DESCRIPTION OF THE DRAWINGS

FIG. 1 is a differential scanning calorimetry (DSC) trace showing the onset, midpoint, and endpoint Tg of a conventional resin as compared to a bio-derived resin according to the present embodiments;

FIG. 2 is a DSC trace showing the onset, midpoint, and endpoint Tg of a control toner as compared to a bio-based toner according to the present embodiments (the resulting curves are staggered so they are clearly visible);

FIG. 3 is a chart illustrating fusing latitude of a control toner as compared to a bio-based toner according to the present embodiments; and

FIG. 4 is a chart illustrating blocking performance of a control toner as compared to a bio-based toner according to the present embodiments.

### DETAILED DESCRIPTION

In the following description, it is understood that other embodiments may be used and structural and operational changes may be made without departing from the scope of the present disclosure.

Energy and environmental policies, increasing and volatile oil prices, and public/political awareness of the rapid depletion of global fossil reserves have created a need to find sustainable monomers derived from biomaterials. The present embodiments disclose bio-derived resins and the use of those resins for toner compositions. By “bio-derived” or “bio-based” is used to mean a material comprised of one or more monomers that are derived from plant material. By using bio-derived feedstock, which are renewable, manufacturers may reduce their carbon footprint and move to a zero-carbon or even a carbon-neutral footprint. Bio-based polymers are also very attractive in terms of specific energy and emission savings. Utilizing bio-based feedstock can help provide new sources of income for domestic agriculture, and reduce the economic risks and uncertainty associated with reliance on petroleum imported from unstable regions.

In chemically prepared toners, such as those resulting from an emulsion aggregation, or suspension polymerization process, a higher Tg shell may be placed over the lower Tg core. The higher Tg shell will help prevent the poor blocking properties of the low Tg core. For an extruded toner, like that which is described in the present disclosure, there is no core and shell structure. Therefore, low Tg materials are particularly problematic with regard to blocking. The present inventors have used the combination of a high Tg petroleum based resin (onset Tg˜61° C.) and a bioderived resin with a onset Tg of about 30 C to about 40 C or in a particular embodiment, 34 C, to make a novel toner. When this formulation was used to make the toner, it was surprisingly discovered that the inventors could incorporate up to about 25% bio-content into the overall toner formulation. The bioderived resin has about 50% bio-content so it takes about 50% of the toner formulation to achieve 25% bio-content. It was further discovered that the resulting toner had superior fusing performance relative to the high Tg non-bio toner formulation currently on the market. For example, the novel formulation of the toner substantially increased fusing latitude by 20° C. In addition, the resulting toner with up to 25% bio-content also had good storage (blocking) performance.

Disclosed herein are amorphous polyester resins for use in toner fabrication that contain up to 25 percent by weight of bio-derived content, or from about 15 to about
percent by weight of bio-derived content, or from about 20 to about 25 percent by weight of bio-derived content, as based on the total weight of the resin. In embodiments, the bio-derived content comprises one or more monomers that are derived from a plant material, such as for example, soy or cottonseed. In embodiments, the polyester resin with partial bio-content is a melt-mixed blend of bio-derived resin and petroleum derived resin. The resins are described below.

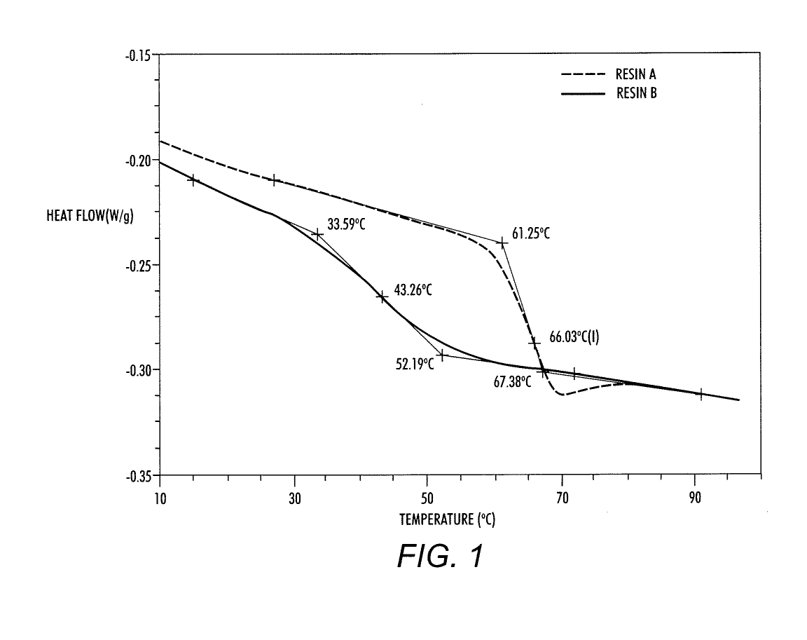

The partial bio-content resins are made by dry blending resin with bio-content with a non-bio petroleum resin. This mixture of resins is added with other ingredients such as colorant, charge control agents, and wax to make the toner. Melt extrusion of a highly bio-derived amorphous polyester resin having low Tg range and a bio-derived content of about 50 percent or more, with a petroleum-derived amorphous polyester resin having a high Tg range in an extruder to produce a bio-based toner. The formulation of the highly bio-derived amorphous polyester is described in U.S. Pat. No. 7,887,982, Table 2B, Example 3, which is hereby incorporated by reference. Up to 10% crosslinking agents, such as trimethylpropane, may be added to adjust the rheology as needed. Any suitable dimer acid may be used. For example, the dimer acid may be obtained from cotton seeds. The petroleum based resin is a polyester produced from about a 50:50 mixture of polyalcohol and polyacid. On a molar basis the polyalcohol is about 75% propoxylated bisphenol-A and 25% ethoxylated bisphenol-A. On a molar basis the polyacid is about 80% terephthalic acid, 10% dodecylsuccinic acid, and 10% trimellitic acid. FIG. 1 shows a DSC trace of the highly bio-derived amorphous polyester resin as compared to that of the petroleum-derived amorphous polyester resin. The DSC Method used was as follows—approximately 10 mg of sample was weighed into a standard aluminum pan and analyzed using a TA Instruments Q100 by the following temperature program: 0-140° C. @ 10° C./min, 140-0° C. @ 10° C./min, Isothermal 3 min., 0-140° C. @ 10° C./min.

In embodiments, the weight ratio of the highly bio-derived amorphous polyester resin to the petroleum-derived amorphous polyester resin is from about 1:2.5 to about 1:0.9, or from about 1:2.3 to about 1:0.98 in the resin blend. These ratios are for a bioresin containing about 50% biocontent. The specific lot of bioresin used in the examples measured 54% biocontent via ASTM D-6866. In further embodiments, the highly bio-derived resin has a low onset Tg of from about 30 to about 40, or from about 31 to about 38, or from about 32 to about 36 with an endset Tg value about 15° C. higher. Shimadzu T_{1/2} of from about 119° C. to about 108° C., or from about 116° C. to about 110° C. In embodiments, the petroleum-derived amorphous polyester resin has a formula of about a 50:50 mixture of polyalcohol and polyacid. On a molar basis the polyalcohol is about 75% propoxylated bisphenol-A and 25% ethoxylated bisphenol-A. On a molar basis the polyacid is about 80% terephthalic acid, 10% dodecylsuccinic acid, and 10% trimellitic acid. In further embodiments, the petroleum-derived resin has a high onset Tg of from about 50 to about 66° C., or from about 55° C. to about 65° C., or from about 59° C. to about 64° C. with an endset Tg about 8° C. higher than the onset. Shimadzu T1/2 from about 115° C. to about 125° C., or from about 117° C. to about 122° C.

In embodiments, the bio-derived amorphous resin has a broad Tg span with an onset to endset of about 19° C. and the onset Tg occurs between 32° C. and 36° C. In embodiments, the Tg span of about 19° C. of the bio-derived amorphous polyester resin falls entirely within a range of from about 30° C. to about 55° C. In a specific embodiment, the bio-derived amorphous resin has Tg span of about 15° C. that falls entirely within a range of from 33.59° C. to about 52.19° C.

In embodiments, the toner of the present embodiments has an onset Tg range of from about 40° C. to about 53° C., or from about 40C to about 50C, or from about 43 to about 51° C. In embodiments, the toner of the present embodiments has an endset Tg of about 15° C. higher than the onset Tg value. The onset Tg value will vary depending as the biocontent is varied between 15% and 25%.

The highly bio-derived resin and the petroleum-derived resin can be melt blended or mixed in an extruder with other ingredients such as waxes, pigments/colorants and/or one or more additive such as, for example, internal charge control agents, pigment dispersants, flow additives, embrittling agents, and the like, to form a bio-based toner. The resultant product can then be micronized by known methods, such as milling or grinding, to form the desired toner particles. The bio-derived resin of the present embodiments is present in the bio-based toner in an amount of from about 20 to about 90 percent by weight, or from about 22 to about 60 percent by weight, or from about 25 to about 50 percent by weight of the total weight of the toner.

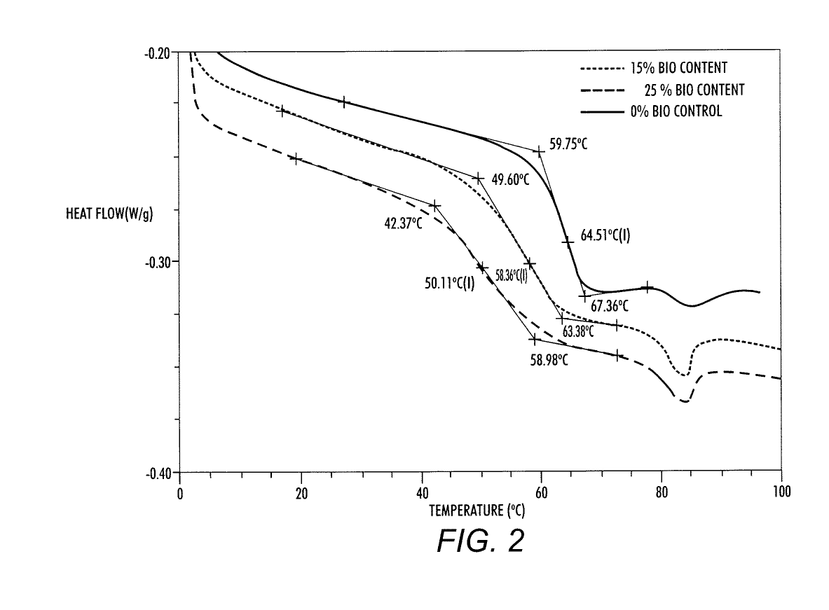

The resulting “green” toner has a broad Tg span and demonstrates a wider fusing latitude while still maintaining good blocking performance as compared to conventional non-green toner compositions. In embodiments, the toner has an onset Tg of from about 35° C. to about 55° C., or from about 40° C. to about 53° C., or from about 43° C. to about 51°. By incorporating the bio-derived amorphous polyester resins of the present embodiments, the inventive toners about doubled the Tg range (about 15° C. versus 8° C.), as shown in FIG. 2. In addition, the toner of the present embodiments exhibited a fusing temperature reduced by about 10° C. to about 20° C. The lower fusing temperature facilitates lower energy consumption as fusing is the largest energy component in the process. In embodiments, the toner has a fusing temperature that begins at 145° C. In further embodiments, the toner has a fusing temperature of from about 145 to about 195° C., or from about 145 to about 165° C. It is believed that the unusually broad Tg range provides for the fusing performance of a low Tg material but is gradual enough to provide blocking resistance during toner storage. Hence, the present embodiments provide a novel toner formulation comprising both a petroleum based resin and a bio-derived polyester resin that has a Tg lower than is conventionally used which can produce a bio-based toner with both excellent fusing performance and good blocking performance.

As described above, the toner can further comprise a wax, colorant, and/or one or more additives.

Waxes

Waxes with, for example, a low molecular weight M_{w} of from about 1,000 to about 10,000, such as polyethylene, polypropylene, and paraffin waxes, can be included in, or on the toner compositions as, for example, fusing release agents.

Colorants

Various suitable colorants of any color can be present in the toners, including suitable colored pigments, dyes, and mixtures thereof including REGAL 330®; (Cabot), Acetylene Black, Lamp Black, Aniline Black; magnetites, such as Mobay magnetites M08029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™, Northern Pigments magnetites, NP-604™, NP-608™; Magnox magnetites TMB-100™, or TMB-104™; and the like; cyan, magenta, yellow, red, green, brown, blue or mixtures thereof, such as specific phthalocyanine HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colored pigments and dyes that can be selected are cyan, magenta, or yellow pigments or dyes, and mixtures thereof. Examples of magentas that may be selected include, for example, 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Other colorants are magenta colorants of (Pigment Red) PR81:2, CI 45160:3. Illustrative examples of cyans that may be selected include copper tetra(octadecyl sulfonamido) phthalocyanine, x-copper phthalocyanine pigment listed in the Color Index as CI 74160, CI Pigment Blue, and Anthrathrene Blue, identified in the Color Index as CI 69810, Special Blue X-2137, and the like; while illustrative examples of yellows that may be selected are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Forum Yellow SE/GLN, CI Dispersed Yellow 33 2,5-dimethoxy-4-sulfonanilide phenylazo-4′-chloro-2,5-dimethoxy acetoacetanilides, and Permanent Yellow FGL, PY17, CI 21105, and known suitable dyes, such as red, blue, green, Pigment Blue 15:3 C.I. 74160, Pigment Red 81:3 C.I. 45160:3, and Pigment Yellow 17 C.I. 21105, and the like, reference for example U.S. Pat. No. 5,556,727, the disclosure of which is totally incorporated herein by reference.

The colorant, more specifically black, cyan, magenta and/or yellow colorant, is incorporated in an amount sufficient to impart the desired color to the toner. In general, pigment or dye is selected, for example, in an amount of from about 2 to about 60 percent by weight, or from about 2 to about 9 percent by weight for color toner, and about 3 to about 60 percent by weight for black toner.

Additives

Any suitable surface additives may be selected. Examples of additives are surface treated fumed silicas, for example TS-530 from Cabosil Corporation, with an 8 nanometer particle size and a surface treatment of hexamethyldisilazane; NAX50 silica, obtained from DeGussa/Nippon Aerosil Corporation, coated with HMDS; DTMS silica, obtained from Cabot Corporation, comprised of a fumed silica silicon dioxide core L90 coated with DTMS; H2050EP, obtained from Wacker Chemie, coated with an amino functionalized organopolysiloxane; metal oxides such as TiO₂, for example MT-3103 from Tayca Corp. with a 16 nanometer particle size and a surface treatment of decylsilane; SMT5103, obtained from Tayca Corporation, comprised of a crystalline titanium dioxide core MT500B coated with DTMS; P-25 from Degussa Chemicals with no surface treatment; alternate metal oxides such as aluminum oxide, and as a lubricating agent, for example, stearates or long chain alcohols, such as UNILIN 700™, and the like. In general, silica is applied to the toner surface for toner flow, tribo enhancement, admix control, improved development and transfer stability, and higher toner blocking temperature. TiO₂ is applied for improved relative humidity (RH) stability, tribo control and improved development and transfer stability.

The SiO₂ and TiO₂ should more specifically possess a primary particle size greater than approximately 30 nanometers, or at least 40 nanometers, with the primary particles size measured by, for instance, transmission electron microscopy (TEM) or calculated (assuming spherical particles) from a measurement of the gas absorption, or BET, surface area. TiO₂ is found to be especially helpful in maintaining development and transfer over a broad range of area coverage and job run length. The SiO₂ and TiO₂ are more specifically applied to the toner surface with the total coverage of the toner ranging from, for example, about 140 to about 200 percent theoretical surface area coverage (SAC), where the theoretical SAC (hereafter referred to as SAC) is calculated assuming all toner particles are spherical and have a diameter equal to the volume median diameter of the toner as measured in the standard Coulter Counter method, and that the additive particles are distributed as primary particles on the toner surface in a hexagonal closed packed structure. Another metric relating to the amount and size of the additives is the sum of the “SAC×Size” (surface area coverage times the primary particle size of the additive in nanometers) for each of the silica and titania particles, or the like, for which all of the additives should, more specifically, have a total SAC×Size range of, for example, about 4,500 to about 7,200. The ratio of the silica to titania particles is generally from about 50 percent silica/50 percent titania to about 85 percent silica/15 percent titania (on a weight percentage basis).

Examples of suitable SiO₂ and TiO₂ are those surface treated with compounds including DTMS (decyltrimethoxysilane) or HMDS (hexamethyldisilazane). Examples of these additives are NAX50 silica, obtained from DeGussa/Nippon Aerosil Corporation, coated with HMDS; DTMS silica, obtained from Cabot Corporation, comprised of a fumed silica, for example silicon dioxide core L90 coated with DTMS; H2050EP, obtained from Wacker Chemie, coated with an amino functionalized organopolysiloxane; and SMT5103, obtained from Tayca Corporation, comprised of a crystalline titanium dioxide core MT500B, coated with DTMS.

Calcium stearate and zinc stearate can be selected as an additive for the toners of the present invention in embodiments thereof, the calcium and zinc stearate primarily providing lubricating properties. Also, the calcium and zinc stearate can provide developer conductivity and tribo enhancement, both due to its lubricating nature. In addition, calcium and zinc stearate enables higher toner charge and charge stability by increasing the number of contacts between toner and carrier particles. A suitable example is a commercially available calcium and zinc stearate with greater than about 85 percent purity, for example from about 85 to about 100 percent pure, for the 85 percent (less than 12 percent calcium oxide and free fatty acid by weight, and less than 3 percent moisture content by weight) and which has an average particle diameter of about 7 microns and is available from Ferro Corporation (Cleveland, Ohio). Examples are SYNPRO® Calcium Stearate 392A and SYNPRO® Calcium Stearate NF Vegetable or Zinc Stearate-L. Another example is a commercially available calcium stearate with greater than 95 percent purity (less than 0.5 percent calcium oxide and free fatty acid by weight, and less than 4.5 percent moisture content by weight), and which stearate has an average particle diameter of about 2 microns and is available from NOF Corporation (Tokyo, Japan). In embodiments, the toners contain from, for example, about 0.1 to about 5 weight percent titania, about 0.1 to about 8 weight percent silica, or from about 0.1 to about 4 weight percent calcium or zinc stearate.

The toner composition can be prepared by a number of known methods including melt mixing the toner resin particles, and pigment particles or colorants, followed by mechanical attrition. Other methods include those well known in the art such as melt dispersion, dispersion polymerization, suspension polymerization, extrusion, and emulsion/aggregation processes.

The resulting toner particles can then be formulated into a developer composition. The toner particles can be mixed with carrier particles to achieve a two-component developer composition.

In embodiments, a charge control agent is added. In further embodiments, the charge control agent is an internal charge control agent, such as an acryl base polymeric charge control agent. In particular embodiments, the toner contains between about 0.5% and 7% by weight of the internal charge control agent.

The toner may be made by admixing resin, wax, the pigment/colorant, and the one or more additives. The admixing may be done in an extrusion device. The extrudate may then be ground, for example in a jet mill, followed by classification to provide a magenta toner having a desired volume average particle size, for example, from about 7.5 to about 9.5 microns, or in a specific embodiment, about 8.4±0.5 microns. The classified toner is blended with external additives, which are specifically formulated in a Henschel blender and subsequently screening the toner through a screen, such as a 37 micron screen, to eliminate coarse particles or agglomerate of additives.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter. The resins used in these examples are defined below:

Resin A

Resin A is the petroleum based resin. This resin has no bio-content. It is a polyester produced from about a 50:50 mixture of polyalcohol and polyacid. On a molar basis the polyalcohol is about 75% propoxylated bisphenol-A and 25% ethoxylated bisphenol-A. On a molar basis the polyacid is about 80% terephthalic acid, 10% dodecylsuccinic acid, and 10% trimellitic acid. This resin has a high onset Tg of about 61.5+/−2.5° C. and an endset Tg value about 8° C. higher than the onset.

Resin B

Resin B is the low Tg bioderived resin with about 50% bio-content based on C-14 analysis. The formulation of the highly bio-derived amorphous polyester is described in U.S. Pat. No. 7,887,982, Table 2B, Example 3. Up to 10% crosslinking agents, such as trimethylpropane, may be added to adjust the rheology as needed. The particular lot of resin used in the examples measured 54% biocontent via ASTM-D6866 carbon-14 analysis. The amounts used in the examples are calculated for a bioresin containing 54% biocontent.

### Example 1

### Preparation of Control Toner (Resin has 0% Bio-Content)

The ingredients listed in Table 1 were added to a Littleford 130D blender. After about 10 minutes mixing time the blended ingredients were discharged and fed into a Werner and Pfleiderer ZSK-25 extruder. The extrusion setpoints were about 45 lb/hr, about 400 RPM, and about 115 degrees C. barrel temperature. The resulting pellets were pulverized in an AFG-200 air jet grinder and size classified to about 8.6 microns volume median size. The resulting size classified particles were Placed in a Henschel 10 L blender and had about silica and titania added to the surface to facilitate flow and charge.

TABLE 1

| Wt % | Component |
|---|---|
| 1.8 | Polypropylene WAX |
| 0.9 | Chromium Dye Charging Agent |
| 0.9 | CARNAUBA WAX |
| 4.9 | Carbon Black |
| 91.5 | Resin A (0% bio) |

### Example 2

### Preparation of Bio-Based Toner 1 (about 15% Bio-Content)

Bio-based toner 1 was prepared like Example 1 except the formulation is as given in Table 2.

TABLE 2

| Wt % | Component |
|---|---|
| 1.8 | Polypropylene WAX |
| 27.7 | Resin B (~50% bio) |
| 0.9 | Chromium Dye Charging Agent |
| 0.9 | CARNAUBA WAX |
| 4.9 | Carbon Black |
| 63.8 | Resin A (0% bio) |

### Example 3

### Preparation of Bio-Based Toner 2 (about 25% Bio-Content)

A toner was prepared like Example 2 except that the formulation was adjusted to contain about 25% bio-content. The formulation is given in Table 3

TABLE 3

| Wt % | Component |
|---|---|
| 1.8 | Polypropylene WAX |
| 46.3 | Resin B (~50% bio) |
| 0.9 | Chromium Dye Charging Agent |
| 0.9 | CARNAUBA WAX |
| 4.9 | Carbon Black |
| 45.2 | Resin A (0% bio) |

Table 4 shows the onset, midpoint, and endpoint Tg values for the control toner as compared to the bio-based toner comprising the low onset, broad Tg bio-derived resin. FIG. 2 demonstrates how the range of Tg has nearly doubled from about 8° C. to about 15° C. for the inventive toners.

TABLE 4
Table 4

| | Tg | Tg | Tg | Tg |
|---|---|---|---|---|
| Sample | Onset | Midpoint | Endset | Span Onsent |
| ID | (C.) | (C.) | (C.) | to Endset |
| Control Toner | 61 | 66.3 | 68.9 | 8 |
| (0% bio- | | | | |
| content) | | | | |
| Toner with 15% | 50.3 | 58.3 | 64 | 14 |
| bio-content | | | | |
| Toner with 25% | 43.4 | 50.6 | 58.4 | 15 |
| bio-content | | | | |

Testing of Toner Performance

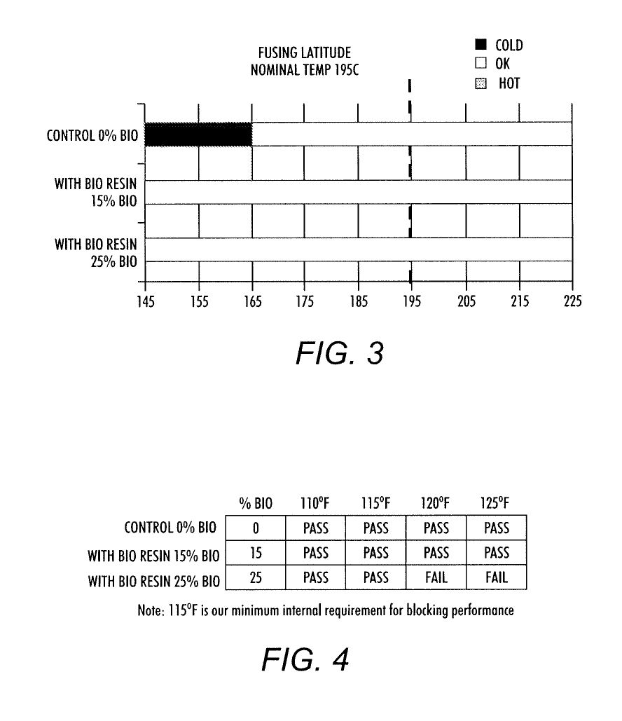

FIG. 3 demonstrates how the inventive bio-based toner exhibits broader fusing latitude relative to the control toner (having no bio-content). A Xerox Workcentre 5655 was used to make the fused prints. Toner 1 comprises 15 weight percent of the bio-derived resin and Toner 2 comprises 25 weight percent of the bio-derived resin. “COLD” stands for cold offset, “OK” is acceptable fusing performance, “HOT” stands for hot offset. The results demonstrated that the fusing temperature for the bio-based toner was up to
C less than that for the control toner, thus requiring much less energy to use than the control toners. In addition, it was shown that fusing of the inventive bio-based toner at 195 C could be done much faster than fusing of the control toner at the same temperature due to the increased fusing latitude.

FIG. 4 demonstrates the blocking performance of the toners. Samples of the toners were placed in oven at the desired setpoint overnight. For example, day one would be 110° F., day 2 would be 115° F., etc. The next day the appearance of the toner would be evaluated. Green (pass) indicates the toner was still fluffy and powder-like while red (fail) indicates the toner particles began to fuse together and become crusty. As can be seen, the blocking performance meets our minimum internal requirements.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A toner comprising:
a resin blend comprising
an amorphous petroleum based polyester resin, the amorphous petroleum based polyester resin having a Tg from about 59° C. to about 64° C. and
a bio-derived amorphous polyester resin having a broad Tg span with an onset to endset of about 19° C. and the onset Tg occurs between 32° C. and 36° C.;
a colorant; and
one or more optional additives, wherein the toner has a fusing temperature that begins at 145° C.
wherein an onset to endset Tg of the resultant toner spans about 15° C.

2. The toner of claim 1, wherein the Tg span of about 19° C. of the bio-derived amorphous polyester resin falls entirely within a range of from about 30° C. to about 55° C.

3. The toner of claim 1, wherein the toner has an onset Tg between 40° C. and 50° C.

4. The toner of claim 1, wherein the toner has a fusing temperature of from about 145° C. to about 225° C.

5. The toner of claim 4, wherein the toner has an improved low temperature fusing temperature of from about 145° C. to about 165° C.

6. The toner of claim 1, wherein the bio-derived amorphous polyester resin is present in the toner in an amount of from about 25 to about 98 weight percent by total weight of the toner.

7. The toner of claim 6, where the amount of bio-derived amorphous polyester is adjusted to achieve 15% to 25% bio-content.

8. (canceled)

9. The toner of claim 1, wherein the resin blend comprises a weight ratio of the bio-derived amorphous polyester resin to the petroleum derived resin of from about 1:2.5 to about 1:0.9.

10. The toner of claim 9, wherein the resin blend comprises a weight ratio of the bio-derived amorphous polyester resin to the petroleum derived resin of from about 1:2.3 to about 1:0.98.

11. The toner of claim 1, wherein the resin blend is a melt-mixed resin blend.

12. The toner of claim 1, wherein the toner has an onset Tg range of from about 40° C. to about 50° C.

13. The toner of claim 1 demonstrating no blocking at a temperature under 120° F.

14. The toner of claim 13 demonstrating no blocking at a temperature under 115° F.

15. The toner of claim 1, wherein the one or more optional additives are selected from the group consisting of internal charge control agents, pigment dispersants, flow additives, embrittling agents, and mixtures thereof.

16. (canceled)

17. (canceled)

18. A method of making a toner comprising
melt-mixing a petroleum based resin and a bio-derived amorphous polyester resin to obtain a resin blend, wherein the bio-derived amorphous polyester resin has a broad Tg span with an onset to endset of about 19° C. and the onset Tg occurs between 32° C. and 36° C.;
admixing the resin blend with a colorant and one or more optional additives to form a toner mixture;
grinding the toner mixture; and
classifying the ground toner mixture to form a toner.

19. The method of claim 18, wherein the ground toner mixture is classified to from a toner having a particle size of about 8.4±0.5 microns. [

20. The method of claim 18, wherein the toner has a fusing temperature that begins at 145 C.
